(19) United States
(12) Patent Application Publication
(10) Pub. No.: US 2010/0190535 A1
(43) Pub. Date: Jul. 29, 2010

(54) Universal Adaptor for Different Chargers and Different Cellular Telephones

(76) Inventor: Yaniv Cohen, Sderot (IL)

Correspondence Address: UZI EZRA HAVOSHA & PARTNERS, HADAR-DAFNA HOUSE 39 SHAOUL HAMELECH STREET, TEL AVIV, 64928, IL

(21) Appl. No.: 12/538,150

(22) Filed: Aug. 9, 2009

Related U.S. Application Data
(60) Provisional application No. 61/088,017, filed on Aug. 12, 2008.

(51) Int. Cl. H04W 88/02

(52) U.S. Cl. 455/573

(57) ABSTRACT

An adaptor with few different power input connectors for connecting the adaptor to various cellular telephone chargers :from one side, and with few different power output connectors for connecting the adaptor to various cellular telephones from the other side. The adaptor enables to charge different cellular telephones by chargers that directly, without the adaptor would not fit to be connected one to the other.

### FIELD OF THE INVENTION

This invention is in the field of cellular telephones and in particular a universal adaptor enabling to charge different cellular telephones by different chargers that normally would not fit to be connected one to the other.

### BACKGROUND OF THE INVENTION

Cellular telephones became so popular and vastly used that not only that almost anyone has cellular telephone but many people have even more then one device. With the growth in the number of the devices there is also a big growth in the designs and models and accordingly in the chargers. There are many different companies that manufacture cellular phones and each has different chargers to fit only to their cellular telephones and even in the same company different phones fit to different chargers. Therefore a person need to have his own specific charger next to him if he wants to charge his phone, the odd to find somebody with the same charger is getting smaller and smaller. Also frequently a person who has more then one device or a family with few devices have almost the same number of chargers each fit only to a specific cellular telephone. This create a mess, confusion and make things more encumber, in order to simplify things and make them more efficient what is needed is one universal adaptor that would enable to charge different cellular telephones with one single charger even if this charger is not specific designed for those cellular telephones.

### SUMMARY OF THE INVENTION

It is to be understood that both the foregoing general description and the following detailed description present embodiments of the invention and are intended to provide an overview or framework for understanding the nature and character of the invention as it is claimed.

This invention reveals an adaptor for charging cellular telephones by chargers that would not normally fit to the connecting members of the device directly. The adaptor would include few different female connecting members that would fit to connect to different chargers with different male connecting members, and few male connecting members that would fit to connect to different cellular telephones with different female connecting members.

The adaptor would enable to take any cellular phone and connect it to the adaptor by a fitted output connecting member in order to charge it by a charger that would be connected to the adaptor by a fitted input connecting member, even if the charger by itself is not fit to connect to this specific cellular telephone.

The adaptor might be dedicated to be used by one cellular company and would be designed for the devices of that company only, or might include plurality of different output and input connecting members enabling the connection to different devices and chargers from different companies.

For the adaptor to be as universal as possible the connecting members, both female and male, of the adaptor might be flexible and changeable by dedicated buttons that by pressing on them would change the size of the connecting members in the adaptor to fit to the connecting members of the cellular telephone and of the chargers. For example if a male connecting member of the adaptor is a rectangle of 7 millimeters and the female connector member of the cellular telephone is a rectangle of 5 millimeters, by pressing the button on the adaptor it would adjust the connecting member of the adaptor to the right size i.e. 5 millimeters, to fit to the connecting member of the cellular telephone.

Alternatively, for increasing the number of cellular phones and chargers that would fit to the adaptor there might be an option to have the original adaptor and to have external secondary adaptors fitted to be connect to the original adaptor that would be sold separately according to the specific cellular phones, so when a person changes his phone he would not need to buy the whole charger but only the secondary adaptor fit to his new cellular telephone. The adaptor might include an output of a USB connection or any other fitted connecting member that would enable to connect the cellular phone to a computer or other devices such as television, stereo, or any other device that the cellular telephone might be connected to for downloading different information as pictures, video, and/or even for charging the cellular telephone.

The adaptor might be used also as a transformer.

Occasionally, different cellular telephones require different electric current flow for charging and therefore they need their specific original charger. The adaptor as a transformer would be able to adjust the electric current flowing from the charger to fit to electric power needed for the cellular telephone. Furthermore, the adaptor might have an automatic safety switch off in cases of external change of electrical current.

Another possibility for the adaptor is to include a digital screen for displaying the information of the cellular phones connected to the adaptor, for example information as the company and the designed of the cellular phone and even the accurate electric current needed.

The adaptor might be designed in a way that would enable the user to hold and speak on the cellular telephone while it is connected to the adaptor and being charged.

The adaptor might also be designed in a way that would enable to charge more then one device at the same time, for example the shape of a hexagon or an octagon wherein each cellular phone would be connected to the adaptor on a different side.

### BRIEF DESCRIPTION OF THE DRAWINGS

The accompanying drawings are included to provide a further understanding of the invention and are incorporated into and constitute a part of this specification. The drawings illustrate various embodiments of the invention and, together with the description, serve to explain the principles and operations of the invention, by way of example only and not to limit the invention to these descriptions only.

FIG. 1 is a schematic diagram reflecting the concept of the universal adaptor.

FIG. 2 is a schematic diagram of a universal adaptor in an octagon shape.

FIG. 3 is a schematic diagram reflecting the adaptor being used as a connection to a computer and the possibility of using an external secondary adaptor.

FIG. 4 is a schematic diagram of a universal adaptor with flexible and changeable connecting members.

### DETAILED DESCRIPTION OF THE PREFERRED EMBODIMENTS

As will be appreciated the present invention is capable of other and different embodiments than those discussed above and described in more detail below, and its several details are capable of modifications in various aspects, all without departing from the spirit of the invention.

Accordingly, the drawings and description of the embodiments set forth below are to be regarded as illustrative in nature and not restrictive.

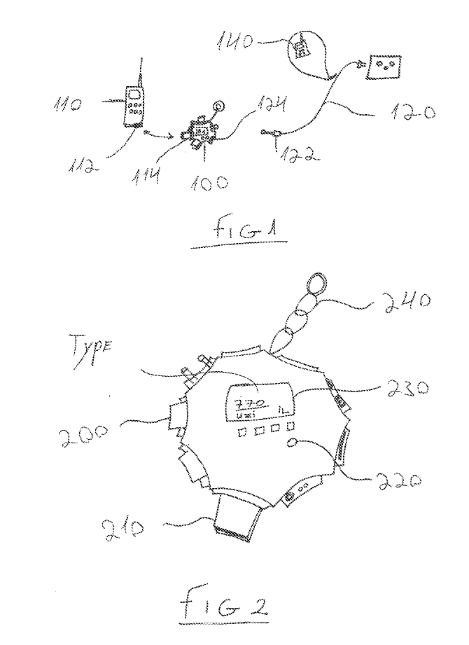

FIG. 1 shows the adaptor 100 that would be connected to a cellular telephone 110 from one side and to a charger 120 from the other side. The cellular telephone 110 has a female connecting member 112 that is not fit to the male connecting member 122 of the charger 120 that is belong to a different cellular telephone 140. Nonetheless, the cellular telephone 110 would be connected to the adaptor to a male connecting member 114 that is fit to connect to the female connecting member 112. The charger 120 would also be connected to the adaptor to a female connecting member 124 that is fit to the male connecting member 122.

Therefore the adaptor enables to a cellular telephone 110 to be charge by a charger 120 that is belong to a different kind of cellular telephone 140 that has a connecting member that is not fit to the cellular telephone 110.

FIG. 2 is shows a universal adaptor in the shape of an octagon with four different female connecting members and four male connecting members. The octagon shape enabling to charge more then one cellular telephone at the same time, for example one cellular telephone might be connected to the male connecting member 200 and the second device would be connected to the male connecting member 210 that is in another side.

A small light fixture 220 might be place on the adaptor indicating when the cellular telephone in being charged or when the battery if full and the charging is being over with a red and green light for example. A digital screen 230 might also be placed on the adaptor displaying different information on the cellular phones connected to the adaptor as the company and the designed of the cellular phone and even the accurate current electricity needed.

A chain 240 of a key holder might be added to the adaptor turning the adaptor to be used also as a key holder, promising that the adaptor would always be close to the user.

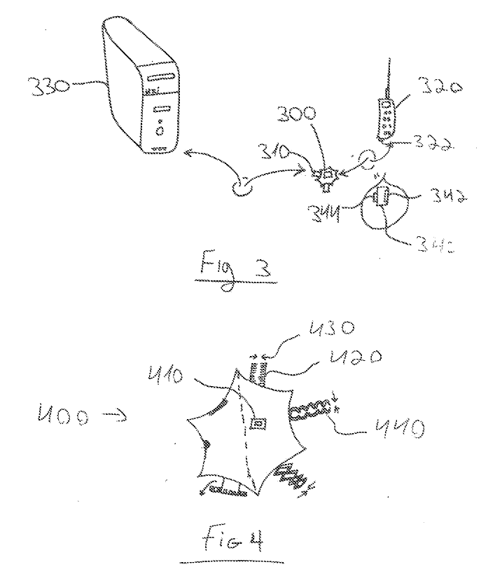

FIG. 3 shows an original adaptor 300 that would include an output of a USB connection 310 for connecting the cellular phone 320 to a computer 330 for downloading different information as pictures, video, or even for charging the cellular telephone.

The external secondary adaptor 340 might be added for connecting the cellular phone 320 that has a female connecting member 322 that is not fit to any of the male connecting members that included in the original adaptor 300. The external secondary adaptor 340 would have a specific male connecting member 344 fitted to connect to the female connecting member 322 of cellular telephone, and a female connecting member 342 fitted to one of the male connecting members in the original adaptor 300. The external secondary adaptors enable to increase the number of cellular phones and chargers that would fit to the adaptor and would reduce the cost of buying a new charger when buying new cellular telephone by enabling to buy only the secondary adaptor that is fitted to his new cellular telephone.

FIG. 4 shows a universal adaptor 400 with flexible and changeable connecting members. Pressing the button 410 would enable to change and adjust the size of the connecting member 420 in the adaptor 400 to fit to the connecting member of a specific cellular telephone. For example the rectangle connecting member 420 might be smaller or bigger by bringing the edges closer to each other or away from each other 430. The same would be with a rounded connecting member 440.

What is claimed:

1. a removable adaptor for charging different cellular telephones by different chargers, comprising:
An adaptor for charging cellular telephones by chargers include few different female connecting members that would fit to connect to different chargers with different male connecting members in one side of the adaptor,
and, in another side of the adaptor few male connecting members that would fit to connect to different cellular telephones with different female connecting members.
The adaptor would enable to take some cellular phone and connect it to the adaptor by a fitted output connecting member in order to charge it by a charger that would be connected to the adaptor by a fitted input connecting member, even if the charger by itself is not fit to connect to this specific cellular telephone,
And, optionally, the adaptor will have an electronic smart card optionally computerized and optionally dedicated with software's that will have the ability to recognized the electronic characters of the male or female connecting members that are inserted into the adaptor, and will adjust automatically the right current or voltage or ampere or resistance require to each specific device.

2. The adaptor according to clams 1, wherein the adaptor might be dedicated to be used by one cellular company and would be designed for the devices of that company only, or optionally, might include plurality of different output and input connecting members enabling the connection to different devices and chargers from different companies.

3. The adaptor according to clams 1, wherein the adaptor will be a universal device by using the connecting members, female or male, as a flexible parts that are changeable, that by using a dedicated buttons that by pressing on them would change the size of the connecting members in the adaptor to fit to the connecting members of the cellular telephone and of the chargers, that, by pressing the button on the adaptor it would adjust the connecting member of the adaptor to the right size to fit to the connecting member of the cellular telephone.

4. The adaptor according to clams 1, wherein the adaptor have the original adaptor, and furthermore it has external secondary adaptors fitted to be connect to the original adaptor that would be a separate part fitted accordantly to each specific cellular phones, with one side connecting to the input of the cellular telephone and the other side connected to the adaptor, and, when a user changes his phone he would not need to use the whole charger but only the secondary adaptor fit to his new cellular telephone, and both, the original adaptor and the secondary adaptor could be connected to various of chargers, wherein, one side of the original adaptor fitted to be connected to the cellular telephone will have just one connection fitted to the secondary adaptor.

5. The adaptor according to clams 1, wherein the adaptor include an output of a USB or disc-on-key or removable computer hard disk connection or any other fitted connecting member that would enable to connect the cellular phone to a computer or other devices such as television, stereo, or any other electronic or computerized devices that the cellular telephone might be connected to for downloading different information as pictures, video, and/or even for charging the cellular telephone or the device.

6. The adaptor according to clams 1, wherein the adaptor might be used also as a transformer, different cellular telephones require different electric current flow for charging and therefore needs their specific original charger, the adaptor as a transformer would be able to adjust the electric current flowing from the charger to fit to electric power needed for each of the cellular telephone.

7. The adaptor according to clams 1, wherein the adaptor will have an automatic safety switch off in cases of external dangerous change of electrical current.

8. The adaptor according to clams 1, wherein the adaptor will include a digital screen for displaying the information of the cellular phones connected to the adaptor, information such as of the company and the designed of the cellular phone and even the accurate electric current needed.

9. The adaptor according to clams 1, wherein the adaptor will be designed in a way that would enable the user to hold and speak on the cellular telephone while it is connected to the adaptor and being charged.

10. The adaptor according to clams 1, wherein the adaptor might also be designed in a way that would enable to charge more then one device at the same time, for example the shape of a hexagon or an octagon wherein each cellular phone would be connected to the adaptor on a different side.

11. a removable adaptor for charging different cellular telephones by different chargers, comprising:
An adaptor for charging cellular telephones by chargers include few different female connecting members that would fit to connect to different chargers with different male connecting members in one side of the adaptor,
and, in another side of the adaptor few male connecting members that would fit to connect to different cellular telephones with different female connecting members.
The adaptor would enable to take some cellular phone and connect it to the adaptor by a fitted output connecting member in order to charge it by a charger that would be connected to the adaptor by a fitted input connecting member, even if the charger by itself is not fit to connect to this specific cellular telephone,
